(19) United States
(12) Patent Application Publication
(10) Pub. No.: US 2011/0102153 A1
(43) Pub. Date: May 5, 2011

(54) DOCUMENT INCLUDING AN INTEGRATED MICROCIRCUIT DEVICE AND A METHOD OF DETECTING AN ATTACK ON THE PHYSICAL INTEGRITY OF THE DOCUMENT

(75) Inventor: Sandrine Rancien, La Murette (FR)

(73) Assignee: ARJOWIGGINS SECURITY INTEGRALE SOLUTIONS, Jouy Sur Morin (FR)

(21) Appl. No.: 12/935,353

(22) PCT Filed: Mar. 30, 2009
(86) PCT No.: PCT/FR2009/050525

§ 371 Date: Nov. 23, 2010

(30) Foreign Application Priority Data
Apr. 4, 2008 (FR) 08 52257

(51) Int. Cl. H04Q 5/22

(52) U.S. Cl. 340/10.1

(57) ABSTRACT

A document including an integrated microcircuit device, in particular an RFID device, the document including at least one detector configured to detect a change in at least one physicochemical magnitude, which detection is capable of being performed away from the read field of an external reader capable of obtaining at least some information relating to said change from the integrated microcircuit device, the integrated microcircuit device being configured, during communication with the external reader to inform it that there has been an attempt at attacking the physical integrity of the document as a result of detecting a corresponding change of said at least one physicochemical magnitude.

The present invention relates to a security document comprising an integrated microcircuit device, also known as an “E-document”, the document having a detector capable of detecting physical violation of the document.

The invention also relates to a method of detecting an attempted attack on the physical integrity of such a document.

The term “security document” is used to mean any document for which it may be advantageous to avoid any attempted falsification or counterfeiting, regardless of whether the document has the function of identifying a person or an article, where such documents may have a variety of forms: booklet, card, adhesive label, payment means, this list not being limiting.

### BACKGROUND

Security documents are liable to be falsified for numerous reasons, for example in order to extract the integrated microcircuit device present therein and reinsert it in some other document, or to remove a photograph in order to put another in its place, or indeed in order to falsify data, e.g. information that is written or printed on the document.

A security document may be subjected to intrusions or physical violations in various ways, for example using means that are mechanical, thermal, or chemical, or a combination of such means.

When a document is subjected to an attack on its physical integrity by mechanical means, e.g. by manually peeling off one of the layers constituting the document, evidence of falsification may be obtained visually by the tearing or delamination of the fiber or plastics substrate layers making up the document, however such a method of revealing intrusion is not always compatible with the durability that is desired for the document in use. Furthermore, with documents that comprise an incorporated microcircuit device, attackers generally seek to recover the device contained in the document and care little that one of the layers constituting the document might be damaged.

Thus, the Applicant has investigated means for detecting a physical violation or an intrusion of a document that comprises an integrated microcircuit, and for informing a user that a falsification action has taken place.

Systems are known for securing E-documents that rely on partial or total destruction of the contactless integrated microcircuit device (also known as a radio frequency identity (RFID) device) during an attempt at falsification. For example, such destruction may correspond to damaging an antenna of the device or to degrading communication between an antenna and a chip.

French patent application FR 2 823 310 in the name of the Applicant describes an adhesive document incorporating an RFID device that is bonded to the document with an adhesive force that is sufficiently weak so that if an attempt is made to falsify the document that is stuck on a medium, part of the RFID device remains on the medium on which it was applied. Thus, should an attacker seek to recover the RFID device, that damages it, thereby spoiling its operation and consequently making it impossible to reuse.

Ensuring that the RFID device is always spoilt nevertheless remains a constraint, given that it is no longer possible to read the data from the chip after falsification, which can itself give rise to problems in certain circumstances. Furthermore, no information relating to the attempted intrusion or physical violation of the document can be given to the user, who can merely observe that the RFID device is not working. That type of adhesive document also has other drawbacks, since it is possible to falsify it without damaging the RFID device in any way, e.g. by dissolving the adhesive of the adhesive document by using a solvent such as hexane.

International application WO 2004/012228 in the name of the Applicant describes a security document including an integrated microcircuit associated with a measurement microcircuit. During fabrication of the document, a particular characteristic of the document is measured using the measurement microcircuit, and the result of the measurement is stored in the memory of the integrated microcircuit. When the integrated microcircuit communicates with an external reader, the measurement microcircuit is activated and measures said characteristic in order to compare it with the measurement previously stored in the integrated microcircuit. If a difference appears between the two measurements, then the document is not authenticated and no data exchange takes place between the integrated microcircuit and the external reader.

Such a document does not manage to take account of all attempts at intrusion or physical violation to which the document may be subjected. A counterfeiter may for example achieve physical intrusion of the document without that giving rise to a change in the measured value of the particular characteristic of the document after intrusion. As a result, when verifying authentication of the document with an external reader, the measurement microcircuit obtains the same result as that stored in the integrated microcircuit. Furthermore, the document does not make it possible to take account of a plurality of attempts at intrusion or physical violation of the document that might have taken place during the lifetime of the document.

International application WO 2004/078787 relates to a method of tracking a package containing a product during shipping in a logistics chain. The package includes an electronic module connected to printed electrical conductor elements of impedance that is measured by the electronic module while the product is being shipped. The electronic module does not have an inductive antenna and it operates by capacitive coupling. At the end of the chain, the results of the impedance measurements are compared with the initial impedance of the electrical conductor elements in order to detect changes in the physical properties of the package during shipping. Thus, in the event of the package being damaged at some moment during shipping, it is possible to know exactly when the damage occurred.

### SUMMARY

There exists a need to increase the security of documents comprising an integrated microcircuit device, and in particular to increase their ability to withstand falsification.

There exists in particular a need to solve the above-mentioned drawbacks so as to provide a document that comprises an integrated microcircuit device and that makes it possible to detect any attempt at falsification and more particularly any attack on the physical integrity of the document.

The invention seeks to satisfy these needs in full or in part.

In one of its aspects, the invention provides a document comprising an integrated microcircuit device, in particular an RFID device, the document comprising at least one detector configured to detect a change of at least one physicochemical magnitude. The change may be caused directly or indirectly by an external stimulus associated with an attempt at falsifying said document. Detection may take place away from the read field of an external reader capable of obtaining from the integrated microcircuit device at least some information relating to the change. While communicating with the external reader, the integrated microcircuit device may be configured to inform the external reader, about one or more attempts at attacking the physical integrity of the document as a result of detecting one or more corresponding changes of said at least one physicochemical magnitude.

The document may be selected from an identity document, e.g. a driver's license, an identity card, a passport booklet or sheet, a ticket, a loyalty card, a gift card, a protection and/or authentication label, a traceability label, a visa, a coupon, payment means such as a check or a bank note.

The document may be a laminate comprising a plurality of fiber and/or plastics substrate layers. The various substrate layers may be laminated together, while hot by welding or melting, or indeed while cold by means of one or more adhesives located between the substrate layers.

The detector may form an integral portion of the integrated microcircuit device or it may be an electronic device that is independent but linked with the integrated microcircuit, e.g. connected via a wire, optical, or radio link, e.g. by inductive coupling.

By means of the invention, it is possible to detect one or more attempts at falsifying the document, giving rise to a change in the physicochemical magnitude. Furthermore, it is possible to detect the slightest attempt at attacking the physical integrity of the document at any time during the lifetime of the document, in particular even in the event of an attacker managing to restore the physicochemical magnitude as it was before the attempt.

By way of example, the detector may be configured to detect a change of the physicochemical magnitude and to inform the integrated microcircuit without receiving any command from some other device, and in particular an external reader for reading the integrated microcircuit.

Furthermore, while the integrated microcircuit device is communicating with the external reader, the invention enables a user to be informed about one or more attempts at attacking the physical integrity of the document.

The invention also makes it possible to detect an attempted attack on the physical integrity of the document without damage to the integrated microcircuit device.

The attempted attack on the physical integrity of the document may correspond to an attempt at intrusion, violation, or falsification of the document, these terms being used herein as being equivalent.

The attempted attack on the physical integrity of the document may be the result of at least one mechanical and/or thermal and/or chemical action on the document.

The “read field” of the external reader may refer equally well to a zone in the proximity of the external reader in which electrical or magnetic coupling is possible with the integrated microcircuit device, or to the possibility of establishing direct electrical contact between the integrated microcircuit device and the external reader.

The term “detector” is used to designate an element suitable for detecting a change in the physicochemical magnitude, in particular in the value of the physicochemical magnitude, and of informing the integrated microcircuit device of said change. The integrated microcircuit is advantageously suitable for storing the change(s) in memory.

The term “physicochemical magnitude” is used to designate a characteristic property or parameter that is intrinsic to the document or to an element present in or on the document, with the value of said parameter or property being modified during an intrusion or a physical violation of the document.

The term “external reader” designates any device making it possible to communicate with the integrated microcircuit device, to activate it, to authenticate it, to read the data contained therein, to receive said data, and where appropriate to modify it, or even to eliminate the data in part or in full. The external reader may operate remotely or by making contact.

The integrated microcircuit device may result from associating a chip with at least one antenna for a contactless system.

By way of example, the chip comprises a semiconductor base, generally a substrate of doped silicon or sometimes made using a semiconductive polymer, and it also generally includes a memory, or even one or more microprocessors enabling data to be processed. In order to operate, it needs to be powered by a source of electricity delivered with or without contact, i.e. when there is no contact, delivered remotely via a communications interface and an antenna. By way of example, the chip is placed at the center of the antenna for contactless power supply of the inductive type or using a construction based on a capacitor, for contactless power supply of the capacitive type, with it being possible for an antenna also to form part of such a construction. With an inductive type power supply, the reader of the chip sends waves that are picked up by the antenna, thereby inducing an electric current that powers and activates the chip. Chips with antennas are referred to as transponders and they generally make use of radiofrequency waves, which is why they are known as radiofrequency identification devices. The same waves, e.g. as a result of being modulated by a signal, e.g. frequency modulated, also enable dialog to take place between the chip and the external reader.

When the integrated microcircuit device is a so-called “active” device, the chip may comprise a battery (or indeed a microbattery) that is incorporated in its integrated microcircuit or it may be connected to a microbattery that is incorporated in the document. The term “battery” should be understood to cover any source of energy of electrochemical origin, whether rechargeable or not.

The integrated microcircuit device is advantageously adapted to contactless communications technology, e.g. as described in the ISO standard 14443.

The integrated microcircuit device of the invention may contain a double-sided electronics module having a contact face and a contactless face for a dual-chip card or it may contain two chips, one for contact technology and the other for contactless technology in a hybrid chip card.

The integrated microcircuit device may comprise an electronic microcircuit capable of processing data derived from the detector evaluating the physicochemical magnitude.

The integrated microcircuit device may comprise the detector, so that the detector is a component element of the integrated microcircuit device. The integrated microcircuit device and the detector may be connected together within a common component. In a variant, the detector may be distinct from the integrated microcircuit device. The detector may be connected or coupled to the integrated microcircuit device, e.g. electrically or magnetically.

The detector may be powered by a battery present on the integrated microcircuit device. In a variant, the detector may be powered by a battery that is external to the integrated microcircuit device.

When the detector and/or the battery powering the detector are distinct from the integrated microcircuit device, these elements may be situated in a common plane within the document. For example, they may be situated on the same substrate layer within the laminate.

In a variant, the detector and the battery powering the detector may be situated on different substrate layers of the layer supporting the integrated microcircuit device.

The detector may be a sensor capable of measuring the physicochemical magnitude.

The detector may be sensitive to at least one external stimulus linked with an attempted attack on the physical integrity of the document on which it is integrated, which stimulus or stimuli may be of a mechanical nature (e.g. peeling the document apart), thermal (attack by means of heat), or chemical (attack with solvents).

The detector may be sensitive to one or more stimuli, either directly (in a single step) or indirectly (in a plurality of steps).

With a single step, the external stimulus may give rise directly to a change in one or more physicochemical magnitudes associated with the stimulus.

For example, a mechanical stimulus such as an attempt at peeling may give rise directly to a variation in the speed and the angle of inclination of one of the layers constituting the document relative to another layer, with these variations being detected by a sensor.

A mechanical stimulus such as an attempt at peeling may also give rise directly to a variation of light level inside layers constituting the document, with such variations being detected by a sensor.

A chemical stimulus such as an attempt at falsification by immersion in one or more solvents may give rise to the presence of a falsification chemical at some given concentration or content, with such variation in concentration being detected by a sensor.

A thermal stimulus such as hot falsification on a hot plate or using a hair dryer may raise the temperature in the core of the document, with that being detected by a sensor.

With a plurality of steps, the external stimulus may give rise indirectly to variation in one or more physicochemical magnitudes. This process may comprise at least a first step in which the external stimulus induces a variation in at least one parameter associated with the stimulus, and a second step in which the variation of at least one parameter associated with the stimulus itself gives rise to variation in one or more physicochemical magnitudes associated with said at least one parameter.

For example, a mechanical stimulus may tear a conductive film present as an intermediate layer in the document, which tear is then detected as a change in electrical conductivity by a sensor.

A mechanical stimulus may give rise to microcapsules incorporated in one or more component layers of the document being ruptured mechanically, these microcapsules containing a chemical species that, on being released, is detected by a change in the concentration of said species in the environment of a sensor.

A chemical stimulus may give rise to an adhesive filled with magnetic particles being dissolved, with that then being detected by a sensor detecting a change in a magnetic magnitude.

A thermal stimulus may also give rise to a solid-to-liquid change of phase of a dye present in one of the intermediate layers of the document, which dye is then detected by an optical sensor as a result of a change in a colorimetric magnitude.

Advantageously, the integrated microcircuit device, and in particular the detector, is configured to detect a change in the physicochemical magnitude at predefined time intervals, in particular once a day, preferably at least twice a day, better at least once an hour, and more preferably continuously. As a result, the invention makes it possible to detect the slightest attempt at intrusion or violation of the document taking place at any time during the lifetime of the document.

The integrated microcircuit device, and in particular the detector, may also be configured to detect any change in the physicochemical magnitude while it is present in the read field of the external reader, in particular on command of the external reader.

The detector may be powered electrically by the integrated microcircuit device. The detector may be powered electrically by magnetic, electrical, or electromagnetic coupling.

The detector may also be electrically powered by a battery, in particular a microbattery on a chip mounted as fine layers on the silicon layer of the integrated microcircuit device.

When the detector requires a higher level of power, it may also be powered by a battery specific thereto, e.g. a battery on a flexible thin layer that is distinct from the chip, such a microbattery being inserted for example in the intermediate layers of the document.

The detector may be powered by a photovoltaic module. In particular, the detector may be powered by a photovoltaic module directly, i.e. continuously providing it is exposed to a light source, and/or via a battery.

During communication between the integrated microcircuit device and the external reader, the device may enable a user to be warned by the external reader that there has been an attempted intrusion or physical violation of the document.

The integrated microcircuit device may be arranged to interrupt or prevent communication with the external reader in the event of the integrated microcircuit device detecting one or more changes of one or more physicochemical magnitudes corresponding to one or more attempted attacks on the physical integrity of the document. The data contained in the integrated microcircuit device may be modified or eliminated, in full or in part, by the external reader in the event of at least one attempted intrusion being detected.

Data contained in the microcircuit device may be eliminated automatically by the integrated microcircuit device itself, after a confirmed attempt at falsification, or during communication with the external reader, and under such circumstances, at the request of the user.

As a result, the integrated microcircuit device may be arranged to eliminate the data it contains automatically without any communication with the external reader, in the event of the integrated microcircuit device detecting a change in the physicochemical magnitude corresponding to an attempted attack on the physical integrity of the document.

In particular, during communication between the integrated microcircuit device and the external reader, the external reader may send commands to the integrated microcircuit device. The integrated microcircuit device may respond by sending information to the external reader relating to one or more attempts at falsification of the document that have taken place and/or may cause the detector to verify the value(s) of the physicochemical magnitude(s) at the time information is being exchanged and to compare said value(s) with the initial value(s).

The invention enables a user to be informed about any attempt at intrusion or physical violation of the document that has taken place without leaving any externally visible sign revealing it.

The invention also makes it possible to remember the slightest intrusion or physical violation that has taken place even if the information relating to said intrusion or violation is communicated to the user only during communication between the integrated microcircuit device and the external reader.

The physicochemical magnitude may relate to a parameter or a property that is detectable and/or measurable by the integrated microcircuit device by means of the detector, said property being modified during a physical attack on the document or a portion of the document.

The physicochemical magnitude may be a characteristic parameter or property that is intrinsic to the document or to an element present in or on the document.

The physicochemical magnitude may in particular correspond to a characteristic of at least one predefined element of the document, in particular of a paper or plastics substrate, a film, an adhesive, an ink or varnish, a powder, an outer coating, or a visible or invisible security element, such as a watermark, for example.

The physical magnitude may also correspond to a characteristic of the document such as the laminate as a whole.

The physical magnitude may also correspond to a characteristic that is intrinsic to the document, such as its brightness. The physicochemical magnitude may relate to a parameter or a property that is mechanical, magnetic, electrical, optical, optionally in the visible range, in particular electromagnetic absorption and/or reflection, thermal, chemical, acoustic, or biological.

Preferably, the physicochemical magnitude is modifiable only by physical violation of the document, e.g. during an attempt at separating a layer constituting the document or during an attack by abrasion or by cutting.

The physicochemical magnitude may be other than an electrical impedance or conductance.

The physicochemical magnitude may be associated with a physical integrity indicator, which preferably determines what physicochemical magnitude is selected.

The term “physical integrity indicator” may cover the detector and part or all of the E-document that is liable to see a change in the physical or chemical magnitude(s) characterizing it under the direct or indirect effect of a stimulus of mechanical, thermal, or chemical nature associated with the attempt(s) at falsification.

For example, the physical integrity indicator may be an oxygen sensor and an opaque card body laminated with an E-document, when the physicochemical magnitude corresponds to measuring a change in oxygen content under the effect of a chemical stimulus associated with giving access to external ambient air during an attempt at peeling the card body.

Also for example, the physical integrity indicator may be the association of a magnetic field sensor and an adhesive comprising magnetic particles forming part of the E-document.

When the document is a foldable document, e.g. a passport, the physical integrity indicator may also constitute a shield and/or an electromagnetic attenuation system when it is situated in a zone that is in register with the integrated microcircuit device.

The physical integrity indicator may comprise an opaque element, in particular when the sensor is sensitive to light.

The document may be such that the physicochemical magnitude and the detector are selected, amongst others, from the following association of physicochemical magnitude and detector:

a magnetic characteristic and an inductive sensor;

a magnetic characteristic and a Hall effect sensor;

a magnetic characteristic and a sensor having a magneto-resistive head;

a magnetic characteristic and a nuclear magnetic resonance sensor;

a movement characteristic and an inclinometer;

a movement characteristic and a gyro;

a movement characteristic and an accelerometer;

an electrical characteristic and a voltmeter;

an electrical characteristic and an ammeter;

an electrical characteristic and an ohmmeter;

an optical characteristic and an optoelectronic sensor, e.g. of the matrix type, e.g. of the charge coupled device (CCD) or complementary metal oxide on silicon (CMOS) camera type;

a colorimetric characteristic and an optoelectronic detector;

a wave absorption characteristic in the visible and/or ultraviolet and/or an infrared range and optical sensor, in particular photodiode or phototransistor;

a wave absorption characteristic in the visible and/or ultraviolet and/or infrared range and a photomultiplier type sensor;

a thermal characteristic and a thermal sensor;

a biological characteristic and a biological sensor;

a chemical characteristic and an electrochemical sensor;

a quantity of light, in particular visible light, and a light sensor e.g. photodiode, phototransistor, or photoresistive or photovoltaic detection sensor;

a chemical compound characteristic, e.g. concentration of the compound, and a sensor for measuring the chemical compound, in particular redox potential or pH;

a concentration of a chemical species and a chemical sensor, in particular a chemical sensor on a thin film;

a concentration of a gaseous species and a gas sensor;

an oxygen content and a sensor for measuring oxygen content.

In another of its aspects, the invention provides a method of detecting an attempted attack at the physical integrity of a document comprising an integrated microcircuit device, in particular an RFID device, the integrated microcircuit device being arranged to detect by means of a detector a change in at least one physicochemical magnitude corresponding to an attempted attack on the physical integrity of the document, the method comprising the steps consisting in:
using the integrated microcircuit device to perform at least one detection of said change while the document is outside the read field of an external reader suitable for receiving at least some information relating to said change from the integrated microcircuit device; and
in the event of one or more changes being detected corresponding to one or more attempts at attacking the physical integrity of the document, informing the external reader about the attempt(s) during communication therewith.

By means of the invention, it is possible to benefit from a method to make it possible to detect any attempt at attacking the physical integrity of the document by detecting an intrusion or a violation outside the read field of the external reader, with information relating to the intrusion or violation being communicated to a user at the time of such communication. As a result, even if an attacker manages to re-establish the value of the physicochemical magnitude after intruding or violating the document, it is still possible to know that such a prior intrusion or violation of the document has occurred by means of the detector that has served to record a change in the physicochemical magnitude.

The method may also comprise the steps consisting in:
preventing or interrupting communication with the external reader in the event of a change being detected that corresponds to an attempted attack on the physical integrity of the document, and/or eliminating or modifying, in full or in part, data contained in the integrated microcircuit device and/or in some other device, in particular the external reader in the event of a change being detected that corresponds to an attempted attack on the physical integrity of the document.

The method may also comprise the steps consisting in:
causing the integrated microcircuit device automatically to eliminate the data it contains without communication with the external reader in the event of the integrated microcircuit device detecting a change of said at least one physicochemical magnitude that corresponds to an attempted attack on the physical integrity of the document.

### DESCRIPTION OF THE FIGURES

The invention can be better understood on reading the following description of non-limiting embodiments thereof, and on examining the accompanying drawings, in which:

FIG. 1 is a diagrammatic view of an example of an electronic passport in accordance with an aspect of the invention;

FIG. 2 is a diagrammatic view of an electronic ticket in accordance with another aspect of the invention;

FIG. 3 is a diagrammatic view of an electronic card in accordance with another aspect of the invention;

FIG. 4 is a diagrammatic view of an example of a playing card in accordance with another aspect of the invention;

FIG. 5 is a diagrammatic view of another example of a passport in accordance with another aspect of the invention; and

FIG. 6 is a diagrammatic view of an example of a document and an external reader, enabling the security method in accordance with the invention to be implemented.

### EXAMPLE 1

### Detecting a Change in Magnetic Properties

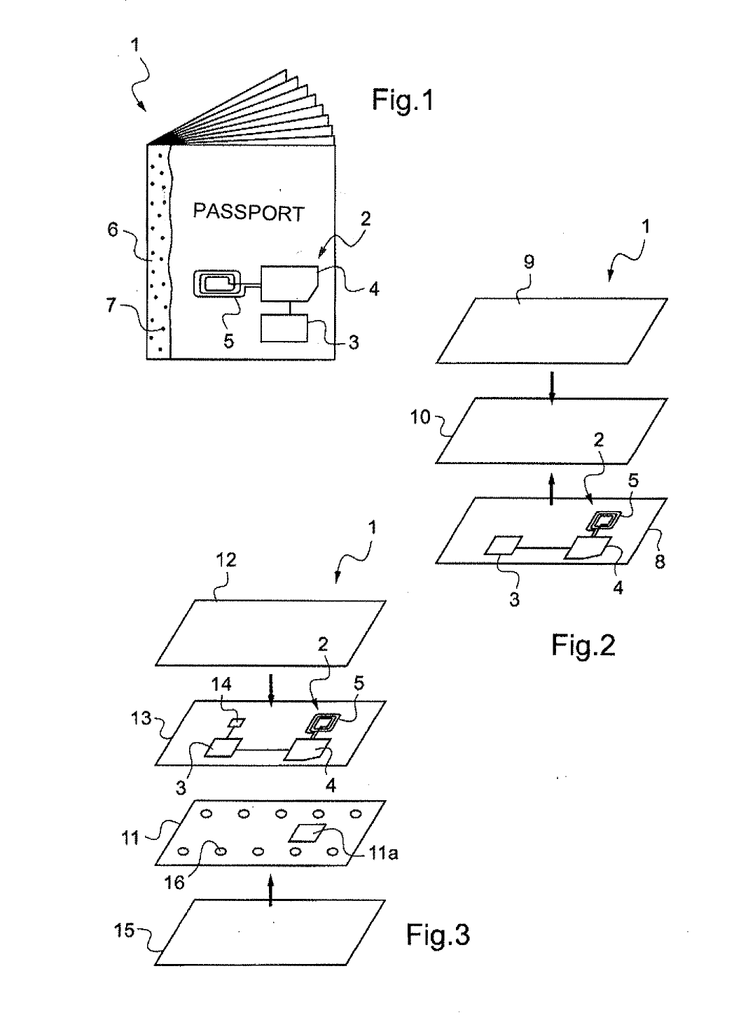

FIG. 1 shows a passport 1 in accordance with an embodiment of the invention.

The cover of the passport 1 comprises a laminate including an RFID device 2 constituted by a chip 4 and a wire antenna 5, the chip being thickness-compensated within the laminate.

The cover of the passport 1 also includes a detector 3 in the form of a magnetic sensor that is connected to the chip 4, but not incorporated in the chip 4.

There is also a layer of adhesive 6 including magnetic particles 7 in the cover of the passport 1, the layer of adhesive 6 serving to hold the laminate that includes the RFID device 2 against the inside face of the cover of the passport 1.

In other embodiments of the passport 1, the layer of adhesive 6 may be situated at other interfaces of the cover of the passport 1, e.g. between the laminate and the flyleaf of the passport 1, without that constituting a drawback for the invention.

In this embodiment, the assembly formed by the magnetic sensor 3 and the layer of adhesive 6 constitutes the physical integrity indicator of the passport 1.

The magnetic property(ies) of the magnetic particles 7, and in particular their remanent magnetization when using a magnetic adhesive that includes particles with so-called “hard magnetism”, constitute the physicochemical magnitude(s) in which a change is detected by the sensor 3.

Initially, in particular during fabrication of the passport 1, the magnetic sensor 3 measures the magnetic properties of the magnetic particles 7 contained in the layer of adhesive 6 and the result of this measurement is stored in the chip 4, or indeed in an external memory (not shown).

The chip 4 may comprise an incorporated microbattery, the microbattery serving in particular to power a Hall effect sensor.

During the lifetime of the passport 1, attempted intrusion or physical violation of the passport 1 is likely to modify the magnetic properties of the magnetic particles 7 contained in the layer of adhesive 6.

For example, an attacker may chemically immerse the passport 1 in a solvent in order to recover the chip 4. Under such circumstances, the layer of adhesive 6 dissolves in the solvent. If the attacker seeks to replace the chip 4 with some other device and uses a new layer of adhesive for reconstructing the passport 1, then the magnetic properties of the magnetic particles 7 will be modified and this change will be detected by the sensor 3 when measuring the magnetic properties of the magnetic particles 7.

In particular, the sensor 3 may measure the magnetic properties of the magnetic particles 7 at regular intervals, e.g. once a week. As a result, any departure of the value of the magnetic properties of the magnetic particles 7 from the initial value as stored in the chip 4 will be detected by the sensor 3.

When in communication with an external reader, the chip 4 will then be capable of informing a user that an attempted intrusion or physical violation of the passport 1 has occurred.

### EXAMPLE 2

### Detecting a Change in the Concentration of a Chemical Species

FIG. 2 is an exploded view of an electronic ticket 1 comprising two layers of paper 8 and 9 that are preferably opaque and that are bonded together by a layer of thermoplastic film 10, that is preferably transparent or translucent.

On its inside face, the layer of paper 8 includes an integrated microcircuit device 2, e.g. constituted by a chip 4 associated with a silkscreen-printed antenna 5.

The chip 4 is also connected to a detector 3, e.g. a chemical sensor 3 on a thin film. The chemical sensor 3 may also be included in the chip 4 without that constituting a drawback.

The chip 4 may also comprise a microbattery for powering the chemical sensor 3.

In this example, the physicochemical magnitude corresponds to the content of the chemical species detected by the chemical sensor 3.

In this example, the chemical sensor 3 constitutes the physical integrity indicator.

When an attacker attempts to perform an intrusion or physical violation of the ticket 1, e.g. by immersing the electronic ticket 1 in a solvent, this is detected by the chemical sensor 3.

Thus, during the lifetime of the ticket 1, the chemical sensor 3 evaluates the content of solvent present in its immediate environment and it detects any change in this solvent content relative to its initial value.

Thus, when the chip 4 is communicating with an external reader (not shown), information is communicated to the user indicating that an intrusion or physical violation of the ticket 1 has taken place.

In a variant that is not shown, provision may be made to incorporate microcapsules in an intermediate ply of the electronic ticket, each microcapsule comprising an envelope that is sensitive to at least one solvent and constraining a chemical species on the inside. The chemical species is released during falsification of the electronic ticket with solvent, and is then detected by the chemical detector. The advantage of this option is that the sensor needs to be sensitive only to the chemical species released by the microcapsules, and not to all solvents that might be used for falsification, as in the above example.

### EXAMPLE 3

### Detecting a Change in an Optical Property

FIG. 3 is an exploded view of a card 1, e.g. of the gift card or loyalty card type comprising two layers of paper 12 and 15 between which there are two other layers of paper 11 and 13. The four layers are laminated together using layers presenting an adhesive property (not shown in the figure).

The layer of paper 13 includes an RFID device 2 on one of its faces, the device being constituted by a chip 4 associated with a silkscreen-printed antenna 5, the chip also being connected to a detector 3, which is an optoelectronic sensor. The layer of paper 11 is provided with a through hole 11a in its zone in register with the chip 4 so that the chip is thickness-compensated in the laminate of paper 11 and paper 13, with the antenna being held inside the laminate.

An optoelectronic sensor 3 is held between the layer of paper 11 and the paper 13. At the request of the RFID device, the optoelectronic sensor measures color at a given time interval, the RFID device being powered continuously, e.g. by means of a battery 14 likewise situated on one of the faces of the layer of paper 13. Optionally, the battery 14 and the sensor 3 may also be thickness-compensated in the laminate of paper 11 and paper 13 by means of a through window or by means of cavities formed in the layers of paper 11 or 13.

The layer of paper 11 includes over all or part of one of its faces, e.g. its face facing the sensor, a phase-change substance 16 and more particularly a coloring substance that is in a solid state up to a certain temperature and that changes to the liquid state on being exposed to a higher temperature. The four layers of paper are cold-laminated using one or more pressure-sensitive adhesives, i.e. adhesives that are suitable for cold lamination, so that the phase-change substance is not released prematurely.

In this example, the physicochemical magnitude corresponds to the colorimetric characteristics of the coloring liquid substance as released by the phase-change substance under the action of temperature.

The optoelectronic sensor 3 and the phase-change substance 16 constitute a physical integrity indicator.

During an attempted intrusion or physical violation of the card 1 by an attacker, in particular by applying heat thereto for the purpose of softening the pressure-sensitive adhesive(s) used for laminating the various layers of paper together, the phase-change substance 16 present on one of the faces of the layer of paper 11 becomes liquid and is thus released.

The optoelectronic sensor 3 then measures or detects the color generated by the release of the liquid substance, and then informs the user of a change of the physicochemical magnitude when the RFID device 2 is in communication with an external reader. The user is thus warned that an attempted intrusion or physical violation of the card 1 has taken place, even if the coloring that results from the intrusion cannot be seen by visual examination.

In a variant, a second sensor 3 may be present between the layer of paper 15 and the paper 13.

### EXAMPLE 4

### Mechanical Stimulus Giving Rise to a Modification of the Electrical Properties of One of the Layers

FIG. 4 is an exploded view of a playing card 1 having two layers of paper 20 and 21 between which there is located a layer of paper 22 and a layer of aluminum 23, e.g. in the form of sheets. The four layers are laminated together by means of layers having adhesive properties (not shown in the figure). The layer of paper 22 includes a microcircuit device, e.g. an RFID comprising a chip 4 and a wire antenna 5, the assembly being located on the face of the layer of paper 22 that faces the layer of paper 21.

The sheet of aluminum 23 acts as an electromagnetic shield, so the data stored in the RFID device can be read only from the side occupied by the layers of paper 21 and 22.

In this example, the chip 4 comprises a detector (not shown) in the form of an impedance sensor.

In this example, the physicochemical magnitude corresponds to the impedance of the sheet of aluminum 23.

The sheet of aluminum 23 and the impedance sensor present in the chip 4 constitute a physical integrity indicator.

Initially, at the time of fabrication of the playing card 1, the impedance sensor of the chip 4 measures the impedance of the sheet of aluminum 23 and stores the result of the measurement in the memory of the chip 4.

During an attempted intrusion or physical violation of the playing card 1 by an attacker, the sheet of aluminum 23 is damaged and the impedance sensor of the chip 4 measures an impedance that is different from the impedance as previously stored.

As a result, when the RFID device 2 communicates with an external reader, it is possible to know whether or not there has been an attempt at intruding or violating the playing card 1.

### EXAMPLE 5

### Mechanical Stimulus Giving Rise to Light being Delivered into an Opaque Laminate

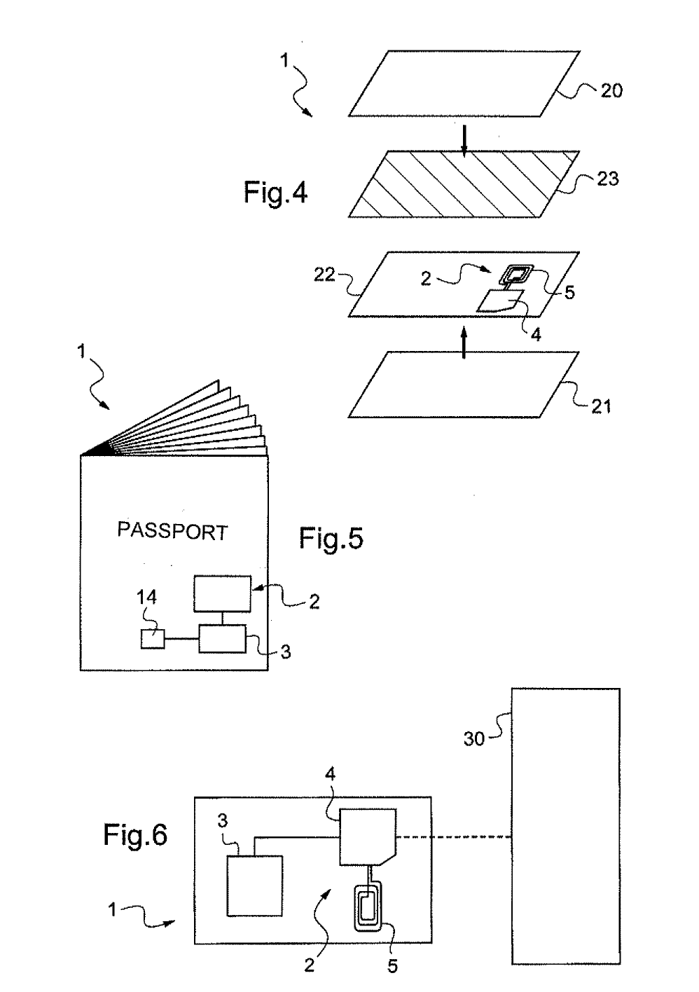

FIG. 5 shows another passport 1 in accordance with an embodiment of the invention.

The cover of the passport 1 may be fabricated from a structure, e.g. as described in application WO 2005/100021 in the name of the Applicant. The structure may be situated between an outside page of the cover and an inside page, and it may be fastened between these pages by means of a cold-cure adhesive.

The structure comprises an integrated microcircuit device 2 and a light sensor 3 that may be a photodiode, a phototransistor, or a photosensitive cell.

The light sensor 3 is electrically powered continuously by a microbattery 14 placed on the structure and connected to the light sensor 3.

Advantageously, the cover of the passport 1 and/or the structure is opaque such that the integrated microcircuit device 2 placed inside the structure is not visible and such that the quantity of light reaching the structure is practically zero, even when the passport booklet is open.

The quantity of light reaching the light sensor 3 constitutes the physicochemical magnitude.

An intrusion or violation of the passport 1, in particular by peeling the cover from the passport 1, causes light to penetrate into the passport 1 and in particular to reach the light sensor 3. The sensor detects a change in the quantity of light reaching it. During communication with an external reader, the integrated microcircuit device 2 can then inform the user that an attempt at falsification has taken place.

### EXAMPLE 6

### Mechanical Stimulus Giving Rise to a Movement of One Layer Relative to Another

FIG. 6 shows another passport 1 in accordance with an embodiment of the invention.

The cover of the passport 1 may be fabricated from a structure as described in application WO 2005/100021 in the name of the Applicant.

The structure may be situated between an outside page of the cover and an inside page and it may be fastened between said pages by means of a cold-curable adhesive.

The structure comprises an integrated microcircuit device 2 and a movement sensor 3, which may be an accelerometer and/or an inclinometer.

By way of example, the movement sensor 3 is electrically powered continuously by a microbattery 14 placed on the structure and connected to the movement sensor 3.

The speed and/or the angle of peeling of one of the component layers of the structure relative to a reference layer, e.g. the cover, constitutes the physicochemical magnitude measured by the movement sensor 3.

An intrusion or violation of the passport 1, in particular by peeling the cover of the passport 1, gives rise to movement of one of the component layers of the electronic cover relative to another. The movement detector 3 then detects this relative change of speed and/or inclination. As a result, during communication with an external reader, the integrated microcircuit device 2 can be used to inform a user that an attempt at falsification has taken place.

Naturally, the invention is not limited to the embodiments described above.

The expression “comprising a” should be understood as being synonymous with “comprising at least one” unless specified to the contrary.

1-25. (canceled)

26. A document comprising an integrated microcircuit device, the document comprising at least one detector configured to detect a change in at least one physicochemical magnitude, which detection is capable of being performed away from the read field of an external reader that is capable of obtaining at least some information relating to said change from the integrated microcircuit device, the integrated microcircuit device being configured, during communication with the external reader, to inform it that there has been an attempt at attacking the physical integrity of the document as a result of detecting a corresponding change of said at least one physicochemical magnitude.

27. A document according to claim 26, the detector being a component element of the integrated microcircuit device.

28. A document according to claim 26, the detector being distinct from the integrated microcircuit device.

29. A document according to claim 28, the detector and the integrated microcircuit device being linked together by connection or by coupling.

30. A document according to claim 26, the detector being powered by a battery present on the integrated microcircuit device.

31. A document according to claim 26, the detector being powered by a battery external to the integrated microcircuit device.

32. A document according to claim 26, the detector being a sensor capable of measuring said at least one physicochemical magnitude.

33. A document according to claim 26, the detector being sensitive to at least one external stimulus associated with an attempted attack on the physical integrity of the document in which it is incorporated, said stimulus or stimuli being capable of being mechanical, thermal, or chemical in nature.

34. A document according to claim 33, the external stimulus giving rise directly to a variation in the physicochemical magnitude(s) associated with said stimulus.

35. A document according to claim 33, the external stimulus giving rise indirectly to a variation of at least one parameter associated with said stimulus, the variation in said at least one parameter itself giving rise to variation in the physicochemical magnitude(s) associated with said at least one parameter.

36. A document according to claim 26, the integrated microcircuit device being configured to detect a change in said at least one physicochemical magnitude at predefined time intervals.

37. A document according to claim 26, the integrated microcircuit device also being configured to detect any change in said at least one physicochemical magnitude when it is present in the read field of the external reader.

38. A document according to claim 26, the integrated microcircuit device being arranged to interrupt or prevent communication with the external reader in the event of the integrated microcircuit device detecting one or more changes in the physicochemical magnitude(s) corresponding to one or more attempts at attacking the physical integrity of the document.

39. A document according to claim 26, the integrated microcircuit device being arranged, automatically and without communication with the external reader, to eliminate the data it contains in the event of the integrated microcircuit device detecting a change in said at least one physicochemical magnitude corresponding to an attempted attack on the physical integrity of the document or part thereof.

40. A document according to claim 26, said at least one physicochemical magnitude relating to a parameter or a property that is detectable and/or measurable by the integrated microcircuit device by means of the detector, said parameter or property being modified during a physical attack on the document.

41. A document according to claim 26, said at least one physicochemical magnitude being a characteristic parameter or property intrinsic to the document or to an element present in or on the document.

42. A document according to claim 41, said at least one physicochemical magnitude being a characteristic parameter or property of at least one predefined element of the document.

43. A document according to claim 26, said at least one physicochemical magnitude being modifiable only by physical violation of the document.

44. A document according to claim 26, said at least one physicochemical magnitude relating to a parameter or a property that is mechanical, magnetic, electrical, optical, electromagnetic absorption and/or reflection, thermal, chemical, acoustic, or biological.

45. A document according to claim 26, said at least one physicochemical magnitude being other than an electrical impedance or conductance.

46. A document according to claim 26, said at least one physicochemical magnitude and the detector being selected from the following associations of physicochemical magnitude and detector:
a magnetic characteristic and an inductive sensor;
a magnetic characteristic and a Hall effect sensor;
a magnetic characteristic and a sensor having a magneto-resistive head;
a magnetic characteristic and a nuclear magnetic resonance sensor;
a movement characteristic and an inclinometer;
a movement characteristic and a gyro;
a movement characteristic and an accelerometer;
an electrical characteristic and a voltmeter;
an electrical characteristic and an ammeter;
an electrical characteristic and an ohmmeter;
an optical characteristic and an optoelectronic sensor;
a colorimetric characteristic and an optoelectronic detector;
a wave absorption characteristic in the visible and/or ultraviolet and/or infrared range and an optical sensor;
a wave absorption characteristic in the visible and/or ultraviolet and/or infrared range and a photomultiplier type sensor;
a thermal characteristic and a thermal sensor;
a biological characteristic and a biological sensor;
a chemical characteristic and an electrochemical sensor;
a quantity of light and a light sensor;
a chemical compound characteristic and a sensor for measuring the chemical compound;
a concentration of a chemical species and a chemical sensor;
a concentration of a gaseous species and a gas sensor; and
an oxygen content and a sensor for measuring oxygen content.

47. A method of detecting an attempted attack on the physical integrity of a document comprising an integrated microcircuit device, the integrated microcircuit device being arranged to detect by means of a detector a change in at least one physicochemical magnitude corresponding to an attempted attack on the physical integrity of the document, the method comprising the steps consisting in:
using the integrated microcircuit device to perform at least one detection of said change while the document is outside the read field of an external reader suitable for receiving at least some information relating to said change from the integrated microcircuit device; and
in the event of one or more changes being detected corresponding to one or more attempts at attacking the physical integrity of the document, informing the external reader about the attempt(s) during communication therewith.

48. A method according to claim 45, comprising the step consisting in:
preventing or interrupting communication with the external reader in the event of a change being detected that corresponds to an attempted attack on the physical integrity of the document.

49. A method according to claim 47, comprising the step consisting in:
at the instigation of the user, eliminating or modifying, in full or in part, data contained in the integrated microcircuit device and/or in some other device.

50. A method according to claim 24, comprising the step consisting in:
causing the integrated microcircuit device automatically to eliminate the data it contains without communication with the external reader in the event of the integrated microcircuit device detecting a change of said at least one physicochemical magnitude that corresponds to an attempted attack on the physical integrity of the document.
